(19) United States
(12) Patent Application Publication
(10) Pub. No.: US 2018/0373865 A1
(43) Pub. Date: Dec. 27, 2018

(54) CALL FLOW-BASED ANOMALY DETECTION FOR LAYERED SOFTWARE SYSTEMS

(71) Applicant: Microsoft Technology Licensing, LLC, Redmond, WA (US)

(72) Inventors: Tolga ACAR, Sammamish, WA (US); Malcolm Erik PEARSON, Kirkland, WA (US)

(21) Appl. No.: 15/633,584

(22) Filed: Jun. 26, 2017

(51) Int. Cl. G06F 21/55

(52) U.S. Cl. CPC G06F 21/552; G06F 2221/033; G06F 21/554

(57) ABSTRACT

Techniques for implementing call flow-based anomaly detection in a layered software system are provided. According to one set of embodiments, a service instance in the layered software system can receive an invocation message indicating invocation of an application programming interface (API) exposed by the service instance. The service instance can further create a log entry including information pertaining to the invocation of the API and a call flow tag, where the call flow tag includes an identifier of a call flow to which the invocation of the API belongs and an ordered series of one or more sub-identifiers indicating a position of the invocation within the call flow. The service instance can then write the log entry to a log store of the layered software system.

### BACKGROUND

Recognizing security incidents in large-scale software systems that comprise a multitude of “layered” software services—in other words, software services that invoke each other in ordered sequences of caller-callee communication patterns—is a difficult task. Traditional approaches to security incident (i.e., intrusion) detection in such systems employ mechanisms that attempt to secure and monitor (1) the network perimeter of the system, (2) the physical servers hosting service instances, and (3) the point-to-point communications between caller and callee service instances. Examples of such mechanisms include network-level access control lists, user authentication and authorization, service-level inbound and outbound call restrictions, and caller authentication/authorization at callee service instances.

While these existing mechanisms are functional for their intended purposes, there are still certain types of security incidents which these mechanisms can fail to detect, either entirely or in a timely manner. For instance, consider a scenario in which an insider (i.e., an authorized user) installs malware on a service instance S1 in an intermediary service layer of a financial payments software system, where the malware is configured to issue application programming interface (API) calls to a callee service instance S2 for the malicious purpose of collecting user credit card information from a secured card vault. Assume that these API calls from S1 to S2 are typically invoked as part of a longer, valid call flow in the system (e.g., a client-initiated call flow for retrieving the client's saved credit card details from the card vault), and thus S1 has the requisite network/service permissions to communicate with S2. In this scenario, since the insider is authorized to access the system's servers, this attack will not trigger any detection mechanisms that are designed to recognize external threats (e.g., network perimeter defenses, user authentication/authorization, etc.). Further, since service instance S1 is authorized to issue the API calls to service instance S2 as part of the system's normal operation, service instance S2 will generally be unable to recognize service instance S1 as being compromised via conventional point-to-point controls/restrictions on caller-callee communications.

### SUMMARY

Techniques for implementing call flow-based anomaly detection in a layered software system are provided. According to one set of embodiments, a service instance in the layered software system can receive an invocation message indicating invocation of an API exposed by the service instance. The service instance can further create a log entry including information pertaining to the invocation of the API and a call flow tag, where the call flow tag includes an identifier of a call flow to which the invocation of the API belongs and an ordered series of one or more sub-identifiers indicating a position of the invocation within the call flow. The service instance can then write the log entry to a log store of the layered software system.

A further understanding of the nature and advantages of the embodiments disclosed herein can be realized by reference to the remaining portions of the specification and the attached drawings.

### BRIEF DESCRIPTION OF THE DRAWINGS

FIG. 1 depicts a simplified block diagram of a layered software system according to certain embodiments.

FIG. 2 depicts an example call flow pattern in the layered software system of FIG. 1 according to certain embodiments.

FIG. 3 depicts a flow diagram for implementing call flow-based anomaly detection in the layered software system of FIG. 1 according to certain embodiments.

FIG. 4 depicts a call flow data collection workflow according to certain embodiments.

FIG. 5 depicts a call flow analysis and action identification workflow according to certain embodiments.

FIG. 6 depicts a simplified block diagram of an example computer system according to certain embodiments.

### DETAILED DESCRIPTION

In the following description, for purposes of explanation, numerous examples and details are set forth in order to provide an understanding of various embodiments. It will be evident, however, to one skilled in the art that certain embodiments can be practiced without some of these details, or can be practiced with modifications or equivalents thereof

### 1. Overview

Embodiments of the present disclosure provide techniques for detecting anomalies in a layered software system (i.e., a software system comprising layered software services) based on call flows that are observed in the system. As used herein, a “call flow” comprises an ordered sequence of API calls that are invoked by the system's service instances in order to execute a task, such as a service request received from a client. In a relatively simple layered software system (or in the case of a relatively simple task), a call flow may be linear in nature; for example, service instance S1 may call API “A1” of service instance S2, which in turn may call API “A2” of service instance S3, which in turn may call API “A3” of service instance S4. In more complex systems and/or tasks, a call flow may exhibit a tree-like structure where one service instance invokes multiple APIs of one or more other service instances, each of which invokes multiple APIs of one or more yet other service instances, and so on.

In various embodiments, the techniques of the present disclosure include collecting data regarding call flows that are executed within a layered software system and analyzing the collected call flow data to determine, among other things, whether the observed call flows are “allowed” flows—in other words, call flows that are recognized as being valid for the system. If the observed call flows are allowed flows, the layered software system can continue operating as normal. However, if any observed call flow is not an allowed flow, the layered software system can conclude that an anomaly (indicative of, e.g., a security incident or other issue) has been detected. The layered software system can then identify and take one or more actions for addressing the anomaly based on various criteria (e.g., the nature of the anomaly, the nature of the call flow, the nature of the system, etc.).

With these techniques, the layered software system can advantageously recognize and act upon certain types of security incidents—for example, attacks that are perpetrated by insiders and/or are difficult to detect via point-to-point caller-callee access control mechanisms—in a manner that is more robust and rapid than traditional intrusion detection approaches. Further, beyond security, these techniques can facilitate the detection of other types of issues that may be surfaced in call flow patterns, such as software bugs, service configuration errors, and regulatory compliance problems. The foregoing and other aspects of the present disclosure are described in further detail below.

### 2. System Architecture and High-Level Flow

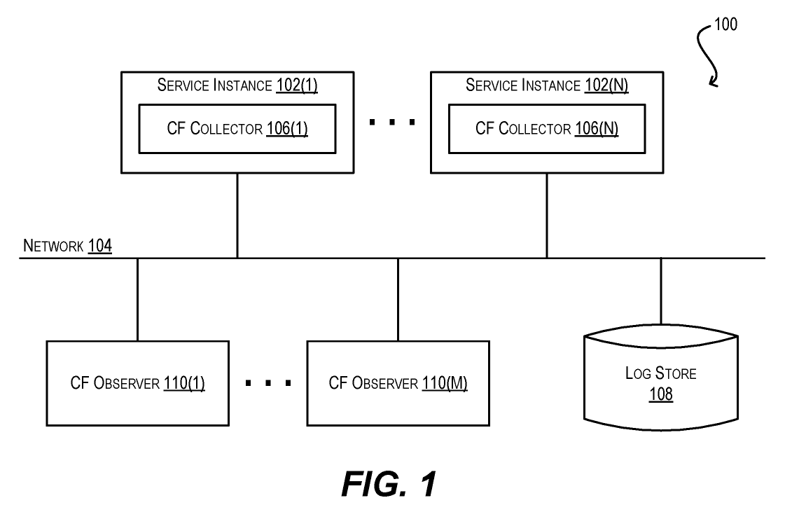

FIG. 1 is a simplified block diagram of a layered software system 100 in accordance with certain embodiments. As shown, system 100 includes a number of service instances 102(1)-(N) that are interconnected via a network 104. Examples of software services that may be represented by service instances 102(1)-(N) include, but are not limited to, financial payment services, hosted business application services, and so on. Service instances 102(1)-(N) can run on a collection of one or more physical and/or virtual servers which may reside in a single location (e.g., a data center) or may be dispersed among multiple geographic locations.

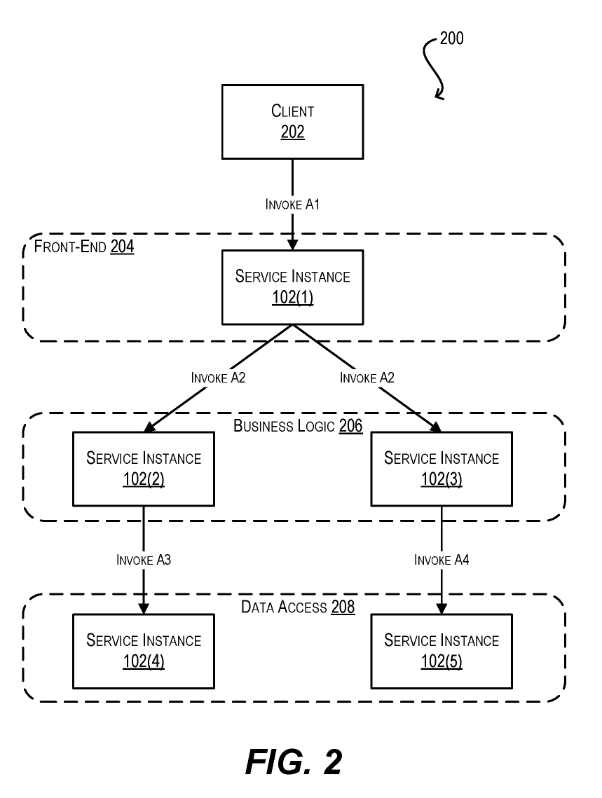

Since software system 100 is a “layered” system, service instances 102(1)-(N) are generally configured to invoke each other according to ordered API call sequences (i.e., call flows) in order to carry out various tasks. For instance, FIG. 2 depicts an example call flow pattern 200 that may be executed by five service instances of system 100 (i.e., instances 102(1)-(5)) in response to a service request initiated by a client 202. In this example, service instance 102(1) is an instance of a “front-end” service layer 204 of system 100, service instances 102(2) and 102(3) are instances of a “business logic” service layer 206 of system 100, and service instances 102(4) and 102(5) are instances of a “data access” service layer 208 of system 100.

As shown in call flow pattern 200, service instance 102(1) can receive the service request from client 202, which includes an invocation of an API “A1” exposed by front-end service layer 204. In response, service instance 102(1) can execute API A1 and issue two downstream API calls to business logic layer 204: a first call of an API “A2” to service instance 102(2) and a second call of the same API A2 to service instance 102(3).

Upon receiving its API call, service instance 102(2) can execute API A2 and issue a downstream API call of an API “A3” to service instance 102(4) of data access service layer 208. Similarly, service instance 102(3) can execute API A2 and issue a downstream API call of an API “A4” to service instance 102(5) of data access service layer 208. Finally, service instances 102(4) and 102(5) can execute APIs A3 and A4 respectively without issuing any further downstream calls, thereby completing/fulfilling the service request. Although not shown in FIG. 2, in certain embodiments call flow pattern 200 may also include one or more return paths from data access service layer 208 back to client 202 in order to, e.g., return data or a transaction acknowledgment to the client.

As noted in the Background section, one challenge with managing a layered software system such as system 100 of FIG. 1 involves comprehensively and quickly detecting security incidents that may arise with respect to the system. Existing intrusion detection solutions focus on securing/monitoring the network perimeter, the physical servers on which service instances run, and the direct (i.e., point-to-point) communications between caller and callee service instances. However, these mechanisms are generally unable to detect attacks that originate from inside the system and that compromise a caller service instance in a manner that prevents the corresponding callee service instance from recognizing the caller's compromised status (e.g., an insider attack that causes the caller service instance to issue API calls which are considered valid from the callee's perspective).

To address this issue and other similar issues, layered software system 100 of FIG. 1 includes a call flow (CF) collector 106 that is part of (or communicatively coupled with) each service instance 102, a log store 108, and a number of call flow (CF) observers 110(1)-(M). CF observers 110(1)-(M) can run on a collection of one or more physical and/or virtual servers that are different from, or overlap with, the server(s) on which service instances 102(1)-(N) run.

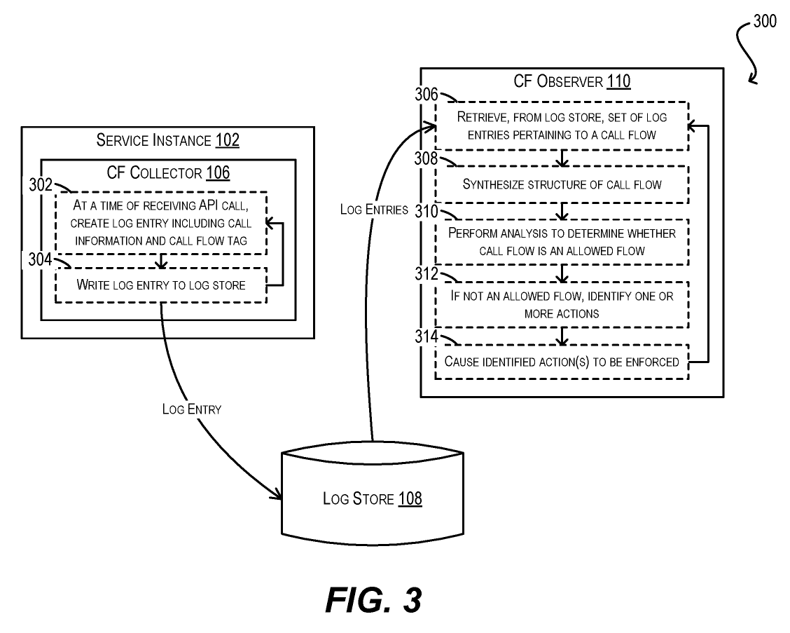

Generally speaking, CF collectors 106(1)-(N) of service instances 102(1)-(N) and CF observers 110(1)-(M) can work in concert to detect anomalies in layered software system 100 (i.e., events indicating abnormal system activity/behavior, such as a security incident) based on the call flows of the system. A high-level flow of this call flow-based anomaly detection approach (flow 300) is depicted in FIG. 3. Starting with block 302 of FIG. 3, at a time a given service instance 102 receives an invocation of an API, CF collector 106 of service instance 102 can create a log entry that comprises information regarding the API call (e.g., service instance identifier, API name, API input parameters, etc.) and a “call flow tag.” In various embodiments, this call flow tag is a data structure (e.g., a vector, array, string, etc.) that includes (1) an identifier of a call flow to which the API call belongs and (2) an ordered series of sub-identifiers that indicate the position of the API call within that call flow. Upon generating the log entry, CF collector 106 can write the entry to log store 108 (block 304). CF collector 106 can then return to block 302 in order to create/write log entries for further API calls, thereby generating a running record in log store 108 of all of the API calls issued to service instance 102 and the call flows to which those API calls belong.

Concurrently with the operation of CF collector 106/service instance 102, each CF observer 110 can, on a continuous or periodic basis, retrieve a set of log entries from log store 108 that pertain to a particular call flow (block 306). Using these log entries, and in particular the call flow tags of the log entries, CF observer 110 can synthesize the structure of the call flow (i.e., the ordered sequence of API calls in the call flow) (block 308). For example, as part of block 308, CF observer 110 may create a call flow graph that is similar in appearance to call flow pattern 200 depicted in FIG. 2.

Then, at block 310, CF observer 110 can perform an analysis to determine whether the synthesized call flow is an allowed flow (i.e., a call flow that is deemed to be valid for system 100). In one set of embodiments, the analysis at block 310 can involve comparing the synthesized call flow against a known group of allowed flows. In other embodiments, the analysis at block 310 can involve applying a set of manually-defined rules that codify the characteristics of an allowed flow. In yet other embodiments, the analysis at block 310 can involve providing the synthesized call flow as input to a machine learning model that has been trained (using, e.g., training data specific to system 100) to identify allowed flows and/or not-allowed flows.

Assuming that CF observer 110 determines the synthesized call flow is not an allowed flow, CF observer 110 can conclude that an anomaly has been detected and can identify one or more actions to take in response to the detected anomaly (block 312). These actions may vary depending on the type of the anomaly/call flow/system and can include, e.g., generating an alert for a service developer or system administrator, generating reporting data/statistics, modifying the behavior of one or more service instances 102(1)-(N), reversing transactions committed via the call flow, shutting down the entire system, and more. In cases where a developer or administrator reviews the call flow and determines that it is not in fact anomalous, this information can be fed back into the set of rules or machine learning model applied at the analysis step of block 310 in order to update that rule set or model.

Finally, at block 314, CF observer 110 can cause the identified action(s) to be enforced by communicating with the entities that are responsible for enforcement. CF observer 110 can thereafter return to block 306 in order to process additional log entries/call flows from log store 108.

With the high-level approach shown in FIG. 3 and described above, a number of benefits can be realized. First, since this approach takes into account entire call flows (rather than separate point-to-point communications between callers and callees) for anomaly detection, this approach can advantageously detect attacks in which a caller service instance is compromised in a way that cannot be recognized by a direct callee service instance but nevertheless result in unusual end-to-end call flows. For example, with respect to call flow pattern 200 of FIG. 2, consider a scenario in which an attacker compromises service instance 102(2) and causes instance 102(2) to issue of a number of calls of API A3 to service instance 102(4) for some malicious purpose (e.g., collecting sensitive/confidential data via data access service layer 208). Note that this type of attack is often perpetrated by insiders, since it involves compromising an internal service instance/server that is typically not accessible by external clients/parties. Further assume that the overall call flow pattern 200 shown in FIG. 2 is an allowed system flow, whereas a call flow solely involving a call of API A3 from service instance 102(2) to 102(4) is not an allowed system flow.

In this scenario, conventional intrusion detection solutions that rely on caller-callee controls/restrictions would not be able to detect this attack, since service instance 102(2) is authorized to invoke API A3 of service instance 102(4) as part of overall call flow pattern 200. However, since the shorter call flow of service instance 102(2) to 102(4) is not an allowed flow, the approach shown in FIG. 3 can correctly detect this attack by recognizing that the shorter call flow is anomalous.

Second, in addition to detecting security incidents, the approach of FIG. 3 can also be used to detect anomalies that may arise from non-security related issues in layered software system 100. Examples of such non-security related issues include software bugs with respect to service instances 102(1)-(N), service/server configuration errors, regulatory compliance issues, and more. Thus, this approach may be broadly applied to detect any domain of system issues/problems that may be surfaced via an analysis of call flow patterns.

Additional details regarding the processing attributed to CF collectors 106(1)-(N) and CF observers 110(1)-(M) in FIG. 3 are provided in the sections that follow.

It should be appreciated that FIGS. 1-3 are illustrative and various modifications are possible. For example, although flow 300 of FIG. 3 indicates that each CF observer 110 performs a single type of call flow analysis for anomaly detection purposes at block 310 (i.e., the analysis of a call flow to determine whether it is an allowed flow), in certain embodiments each CF observer 110 can also perform other types of analyses on the logged call flow data. Examples of these other types of analyses (which include, e.g., a rate-based analysis and a call flow data integrity analysis) are discussed in Section (5) below.

### 3. Call Flow Data Collection

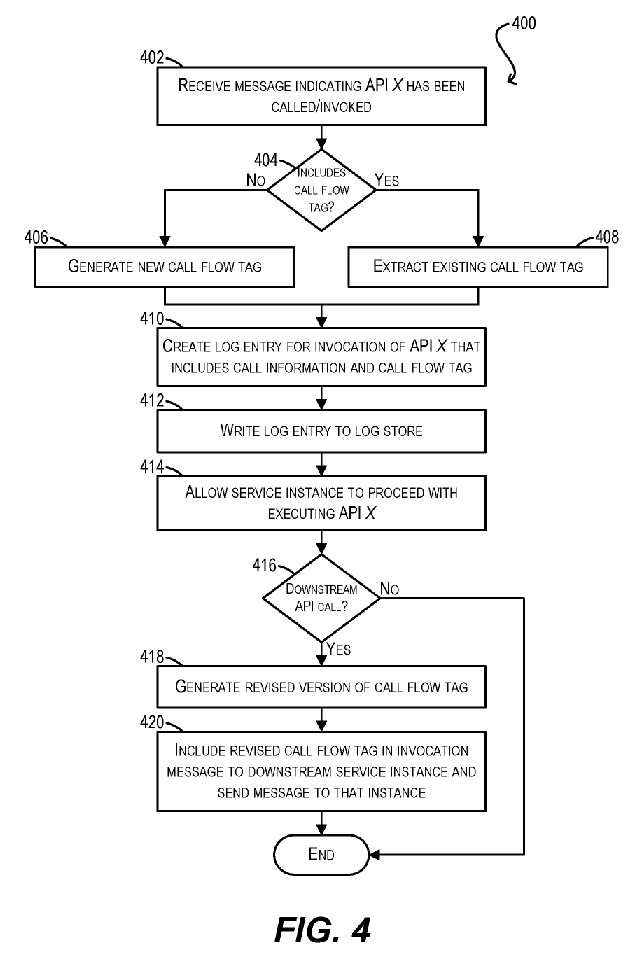

FIG. 4 depicts an example call flow data collection workflow 400 that may be executed by each CF collector 106 in response to the invocation of an API X exposed by the collector's corresponding service instance 102 (per blocks 302 and 304 of FIG. 3) according to certain embodiments.

Starting with block 402, CF collector 106 can receive a message indicating that API X has been called/invoked. In the case where API X is called by an upstream service instance or a client, this message can be a message or data packet that is transmitted by the upstream instance/client. In the case where API X is called by some piece of code that is resident on service instance 102, this message be an inter-process or intra-process message.

At block 404, CF collector 106 can check whether the message received at block 402 includes a call flow tag for the invocation of API X As mentioned previously, this call flow tag is a data structure that includes a call flow identifier indicating the call flow to which the API call belongs and an ordered series of sub-identifiers indicating the position of the API call within that call flow. In one set of embodiments, the call flow tag can exhibit the following format:

[call flow ID].[sub-ID 1].[sub-ID 2].[sub-ID 3]

In these embodiments, each “sub-ID” is an identifier of an API call that has been issued in the context of the call flow identified by “call flow ID” and is ordered in accordance with both its horizontal and vertical position in the call flow. The last “sub-ID” identifies the API call to which the overall call flow tag is associated. By way of example, consider the invocation of API A2 by service instance 102(1) to service instance 102(3) in call flow pattern 200 of FIG. 2. In this case, one example call flow tag for this invocation of A2 may be “XYZ.2-A2,” where “XYZ” is the identifier of a specific call flow instance of pattern 200 and where “2-A2” indicates that this invocation of A2 is the second API call in XYZ (i.e., horizontal position in call flow tree) within the first call flow layer of XYZ (i.e., vertical position in call flow tree).

If CF collector 106 determines at block 404 that there is no call flow tag included in the message, CF collector 106 can conclude that the current invocation of API X is the first call in a new call flow and thus can generate a new call flow tag for this invocation (block 406). As part of this step, CF collector 106 can generate a new call flow identifier (e.g., a randomly generated number) and append a sub-identifier for the invocation of API X to the new call flow identifier.

Alternatively, if CF collector 106 determines at block 404 that there is a call flow tag included in the message, CF collector 106 can conclude that the current invocation of API

X is part of an in-process call flow (as identified by the existing call flow tag). In this case, CF collector 106 can simply extract the existing call flow tag from the message (block 408).

Upon either generating a new call flow tag or extracting an existing call flow tag, CF collector 106 can create a log entry for the invocation of API X based on the contents of the message received at block 402 (block 410). This log entry can include an identifier/name of service instance 102, an identifier/name of API X, the input parameters to API X specified by the caller entity, and the new/existing call flow tag. In certain embodiments, this log entry can also include other information, such as an identity/name of the caller entity, caller authentication information included in the invocation message, and so on.

CF collector 106 can then write the created log entry to log store 108 and allow service instance 102 to proceed with executing API X(blocks 412 and 414). In some embodiments, CF collector 106 may write the created log entry to a particular data structure in log store 108 that is associated with the call flow identifier included in the call flow tag (e.g., a call flow-specific log file, database table, directory, etc.). In this way, CF collector 106 can partition the log entries stored in log store 108 on a per-call flow basis.

If the execution of API X by service instance 102 does not result in the issuance of any downstream API calls (block 416), workflow 400 can end. However, if the execution of API X does result in the issuance of at least one downstream API call, CF collector 106 can generate a revised version of either the new call flow tag generated at block 406 or the existing call flow tag extracted at block 408 that appends a new sub-identifier corresponding to the downstream call (block 418). Although not shown, if there are multiple downstream API calls, CF collector 106 can generate multiple revised call flow tags that build upon each other (e.g., revised version 1 is used as a basis for revised version 2, revised version 2 is used as a basis for revised version 3, etc.) in order to generate an appropriate tag for each call.

Finally, at block 420, CF collector 106 can include the revised call flow tag in a message for invoking the downstream API and can transmit/provide the message to the service instance that is the target of the invocation.

### 4. Call Flow Analysis and Action Identification

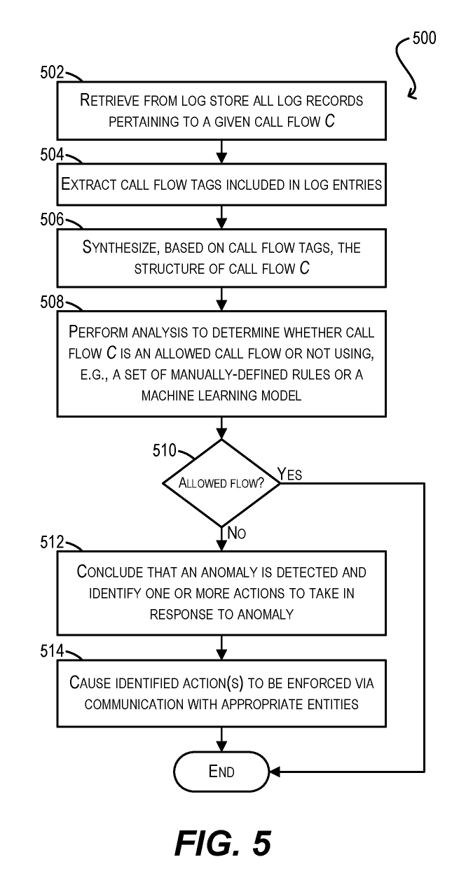

FIG. 5 depicts an example workflow 500 that may be executed by each CF observer 110 for processing log entries for a given call flow C for anomaly detection purposes (per blocks 306-314 of FIG. 3) according to certain embodiments. For clarity of explanation, workflow 500 assumes that the operation of each CF observer 110 is independent from the operation of service instances 102(1)-(N). Stated another way, workflow 500 assumes that each CF observer 110 performs its call flow analysis and action identification in an offline, or asynchronous, manner with respect to the actual call flows executed by service instances 102(1)-(N). However, in some embodiments CF observers 110(1)-(M) may perform their activities in an online/synchronous manner, which is discussed separately in Section (5) below.

At block 502, CF observer 110 can first retrieve, from log store 108, all of the log entries recorded by CF collectors 106(1)-(N) for call flow C. In embodiments where log store 108 comprises per-call flow data structures, this step can involve retrieving all of the log entries maintained in the data structure associated with the call flow identifier of C.

At block 504, CF observer 110 can extract the call flow tags included in each log entry. CF observer 110 can then synthesize, based on the extracted call flow tags, the structure of call flow C (i.e., the ordered sequence of API calls within the call flow) (block 506). For example, in one set of embodiments, CF observer 110 can generate a call flow graph that is similar in appearance to call flow pattern 200 of FIG. 2. This synthesizing can be performed using any number of known “data stitching” technologies, such as correlation vector technology.

Once the structure of call flow C has been synthesized, CF observer 110 can perform an analysis to determine whether C is an allowed flow or not (block 508). In one set of embodiments, CF observer 110 may have access to a predefined list of allowed flows. In these embodiments, CF observer 110 may execute the analysis of block 508 by comparing call flow C to each allowed flow in the predefined list and searching for a match. In other embodiments, CF observer 110 may have access to a predefined set of rules that have been manually created by service developers/system administrators and that codify the characteristics of allowed or not-allowed flows. In these embodiments, CF observer 110 may execute the analysis of block 508 by applying each of the predefined set of rules to call flow C. In yet other embodiments, CF observer 110 may have access to a machine learning model that has been trained to recognize allowed or not-allowed flows based on training data that is specific to layered software system 100 (or the type of system that system 100 embodies). In these embodiments, CF observer 110 may execute the analysis of block 508 by providing data regarding call flow C as inputs to the machine learning model and evaluating the model output. In yet other embodiments, CF observer 110 may combine any two or more of the foregoing analysis techniques.

If CF observer 110 determines via the analysis at block 508 that call flow C is an allowed flow (block 510), CF observer 110 can conclude that there is no anomaly with respect to C and workflow 500 can end.

However, if CF observer 110 determines that call flow Cis not an allowed flow (block 510), CF observer 110 can conclude that an anomaly has been detected and can identify one or more actions to take in response to the detected anomaly (block 512). The specific actions that are identified at this step can vary significantly based on a number of different criteria, such as the nature of the anomaly, the nature of call flow C, the nature of layered software system 100, and others. The following is a non-exhaustive list of possible actions (other actions not on this list are believed to be within the scope of the present disclosure and will be evident to one of ordinary skill in the art):
Raise an alert to a human for review/intervention; in the case where the human reviews call flow C and determines that it is not anomalous, feed this decision back into the set of rules or machine learning model applied at block 508 in order to update the rule set/model
Generate reporting data or statistics pertaining to call flow C
Modify the behavior of one or more service instances involved in call flow C; this can include, e.g., implementing one or more user challenges for invoking the functionality/task fulfilled by C, implementing a service instance rule for rejecting or metering future call flows that appear identical or similar to C, and so on
If the anomaly is deemed to be a security incident, attempt to collect information regarding the incident/attacker (e.g., identities of users/machines that have interacted with one or more service instances over a certain time period, logs of data copied from the instance servers, etc.)
Reverse any transactions/data changes/workflows committed or initiated as a result of executing call flow C (e.g., reverse a charge to a credit card, cancel the shipment of a purchase order, cancel a subscription service, etc.)
Log data regarding future occurrences of call flow C (or substantially similar call flows)
Shut down the system

At block 514, CF observer 110 can cause the action(s) identified at block 512 to be enforced via communication with, e.g., service instances 102(1)-(N), log store 108, and/or other entities/systems. Workflow 500 can then terminate.

### 5. Other Features/Enhancements

### 5.1 Inline CF Observer Operation

In certain embodiments, one or more of CF observers 110(1)-(M) can perform their call flow analysis and action identification functions in a manner that is synchronous, or inline, with respect to the call flows executed by service instances 102(1)-(N). For instance, assume that a call flow C passes through a number of service instances and ends at a final (i.e., terminal) service instance T which is configured to perform a secured or sensitive task (e.g., retrieve credit card details, post a charge to a bank account, etc.). In this example, at the time call flow C reaches service instance T, instance T can invoke a CF observer 110 and request that CF observer 110 analyze and provide an answer on whether C is an allowed flow, prior to executing its portion (i.e., API call) of C. Upon receiving this answer, service instance T can proceed to execute the API call (if the flow is deemed to be allowed) or can reject the API call (if the flow is not deemed to be allowed). Thus, with this approach, service instances 102(1)-(N) can be proactive in preventing the execution of anomalous call flows.

Depending on the complexity of its analysis, it is possible that CF observer 110 in the example above may take an extended period of time in order to return an answer to service instance T Thus, this approach may be best suited to service requests/tasks that do not require real-time or near real-time execution. Alternatively, in some embodiments, CF observer 110 may configured to perform only a portion of its analysis in an inline manner (e.g., portions that can be executed quickly, such as the application of a few simple rules) and leave the remaining, more complex analysis portions for offline handling. In this way, CF observer 110 can still provide some level of anomaly detection inline without extended delays.

### 5.2 Other Call Flow Analyses

In addition to (or in lieu of) the “allowed flow” analysis described in FIGS. 3 and 5, in various embodiments CF observers 110(1)-(M) may also implement other types of analyses for anomaly detection purposes. For example, in one set of embodiments, each CF observer 110 can implement a rate-based analysis in which it tracks the rate at which one or more call flows occur (i.e., are invoked) in layered software system 100 over a historical time window. These call flows may be allowed flows or non-allowed flows. If the rate for a particular call flow exceeds a predefined threshold, CF observer 110 can trigger an anomaly and/or action (e.g., impose rate throttling).

In another set of embodiments, each CF observer 110 can implement a call data integrity analysis in which it verifies whether the invocation message content passed between service instances in a given call flow is correct (i.e., has not be tampered with). In these embodiments, CF collector 106 of each service instance 102 can calculate a hash of (1) the invocation message content to be sent to a downstream service instance and (2) a previous message hash received from an upstream service instance (if it exists), and can include this calculated hash value in the invocation message. Upon receiving, the invocation message at the downstream service instance, the CF collector of the downstream service instance can record the message hash value in the log entry written to log store 108.

Then, at the time a CF observer 110 evaluates a call flow, CF observer 110 can examine the chain of message hash values stored in log store 108 for the call flow and determine whether all of the hash values are correct in view of the corresponding message content. If so, CF observer 110 can conclude that the messages in the call flow have not been tampered with. If not, CF observer 110 can identify the modified messages and can take an appropriate action (e.g., raise an alert so that a human can investigate, shut down the affected service instances, etc.).

### 6. Example Computer System

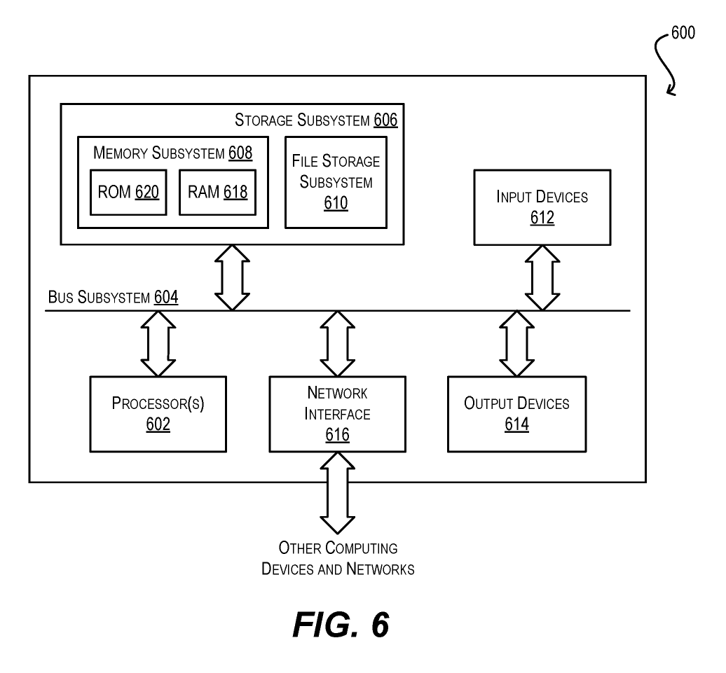

FIG. 6 depicts a simplified block diagram of an example computer system 600 according to certain embodiments. Computer system 600 can be used to host/run any of the software-based entities described in the foregoing disclosure, such as service instances 102(1)-(N) and CF observers 110(1)-(M) of FIG. 1. As shown in FIG. 6, computer system 600 includes one or more processors 602 that communicate with a number of peripheral devices via a bus subsystem 604. These peripheral devices include a storage subsystem 606 (comprising a memory subsystem 608 and a file storage subsystem 610), user interface input devices 612, user interface output devices 614, and a network interface subsystem 616.

Bus subsystem 604 can provide a mechanism for letting the various components and subsystems of computer system 600 communicate with each other as intended. Although bus subsystem 604 is shown schematically as a single bus, alternative embodiments of the bus subsystem can utilize multiple busses.

Network interface subsystem 616 can serve as an interface for communicating data between computer system 600 and other computer systems or networks. Embodiments of network interface subsystem 616 can include, e.g., an Ethernet card, a Wi-Fi and/or cellular adapter, a modem (telephone, satellite, cable, ISDN, etc.), digital subscriber line (DSL) units, and/or the like.

User interface input devices 612 can include a keyboard, pointing devices (e.g., mouse, trackball, touchpad, etc.), a touch-screen incorporated into a display, audio input devices (e.g., voice recognition systems, microphones, etc.) and other types of input devices. In general, use of the term “input device” is intended to include all possible types of devices and mechanisms for inputting information into computer system 600.

User interface output devices 614 can include a display subsystem, a printer, or non-visual displays such as audio output devices, etc. The display subsystem can be, e.g., a flat-panel device such as a liquid crystal display (LCD) or organic light-emitting diode (OLED) display. In general, use of the term “output device” is intended to include all possible types of devices and mechanisms for outputting information from computer system 600.

Storage subsystem 606 includes a memory subsystem 608 and a file/disk storage sub system 610. Sub systems 608 and 610 represent non-transitory computer-readable storage media that can store program code and/or data that provide the functionality of embodiments of the present disclosure.

Memory subsystem 608 includes a number of memories including a main random access memory (RAM) 618 for storage of instructions and data during program execution and a read-only memory (ROM) 620 in which fixed instructions are stored. File storage subsystem 610 can provide persistent (i.e., non-volatile) storage for program and data files, and can include a magnetic or solid-state hard disk drive, an optical drive along with associated removable media (e.g., CD-ROM, DVD, Blu-Ray, etc.), a removable flash memory-based drive or card, and/or other types of storage media known in the art.

It should be appreciated that computer system 600 is illustrative and many other configurations having more or fewer components than system 600 are possible.

The above description illustrates various embodiments of the present disclosure along with examples of how aspects of these embodiments may be implemented. The above examples and embodiments should not be deemed to be the only embodiments, and are presented to illustrate the flexibility and advantages of the present disclosure as defined by the following claims. For example, although certain embodiments have been described with respect to particular process flows and steps, it should be apparent to those skilled in the art that the scope of the present disclosure is not strictly limited to the described flows and steps. Steps described as sequential may be executed in parallel, order of steps may be varied, and steps may be modified, combined, added, or omitted. As another example, although certain embodiments have been described using a particular combination of hardware and software, it should be recognized that other combinations of hardware and software are possible, and that specific operations described as being implemented in software can also be implemented in hardware and vice versa.

The specification and drawings are, accordingly, to be regarded in an illustrative rather than restrictive sense. Other arrangements, embodiments, implementations and equivalents will be evident to those skilled in the art and may be employed without departing from the spirit and scope of the present disclosure as set forth in the following claims.

What is claimed is:

1. A computer system comprising:
a processor; and
a computer readable storage medium having stored thereon program code that, when executed by the processor, causes the processor to:
receive an invocation message indicating invocation of an application programming interface (API) exposed by a software service instance running on the computer system;
create a log entry including information pertaining to the invocation of the API and a call flow tag, wherein the call flow tag includes an identifier of a call flow to which the invocation of the API belongs and an ordered series of one or more sub-identifiers indicating a position of the invocation within the call flow; and
write the log entry to a log store.

2. The computer system of claim 1 wherein the software service instance is part of a service layer in a layered software system and wherein the invocation message is received from another software service instance that is part of another service layer in the layered software system.

3. The computer system of claim 1 wherein the information pertaining to the invocation of the API includes an identifier of the software service instance, a name of the API, and one or more input parameters to the API.

4. The computer system of claim 1 wherein if the invocation of the API is a first invocation in the call flow, the processor generates the call flow tag by generating a random number for the identifier of the call flow and appending a sub-identifier corresponding to the invocation to the random number.

5. The computer system of claim 1 wherein if the invocation of the API is not a first invocation in the call flow, the processor extracts the call flow tag from the invocation message.

6. The computer system of claim 1 wherein the processor writes the log entry to a data structure in the log store that is associated with the identifier of the call flow.

7. The computer system of claim 1 wherein the program code further causes the processor to execute the API after writing the log entry to the log store.

8. The computer system of claim 7 wherein, if execution of the API results in a downstream API call, the program code further causes the processor to:
generate a revised call flow tag for the downstream API call.

9. The computer system of claim 8 wherein generating the revised call flow tag comprises:
determining a new sub-identifier that corresponds to the downstream API call; and
appending the new sub-identifier to the call flow tag.

10. The computer system of claim 8 wherein the program code further causes the processor to:
include the revised call flow tag in a new invocation message for the downstream API call; and
transmit the new invocation message to a target software service instance for the downstream API call.

11. The computer system of claim 1 wherein an observer instance in communication with the computer system is configured to:
retrieve, from the log store, one or more log entries pertaining to the call flow;
extract call flow tags from the retrieved log entries; and
synthesize, using the call flow tags, a structure of the call flow.

12. The computer system of claim 11 wherein synthesizing the structure of the call flow comprises generating a call flow graph illustrating one or more ordered sequences of API calls in the call flow.

13. The computer system of claim 11 wherein the observer instance is further configured to:
perform an analysis to determine whether the call flow is an allowed call flow.

14. The computer system of claim 11 wherein the observer instance is further configured to:
perform an analysis to determine whether an occurrence rate for the call flow within a prior time window exceeds a predefined threshold.

15. The computer system of claim 11 wherein the observer instance is further configured to:
perform an analysis to determine whether invocation message content passed between software service instances as part of the call flow has been tampered with.

16. The computer system of claim 13 wherein if the call flow is an allowed call flow, the observer instance is further configured to:
conclude that an anomaly exists with respect to the call flow;
identify one or more actions to take in response to the anomaly; and
cause the one or more actions to be enforced.

17. The computer system of claim 16 wherein the anomaly is indicative of a security incident with respect to one or more software service instances that are involved in the call flow.

18. The computer system of claim 16 wherein the anomaly is indicative of a software bug or a regulatory compliance issue with respect to one or more software service instances that are involved in the call flow.

19. A method comprising:
receiving, by a software service instance in a layered software system, an invocation message indicating invocation of an application programming interface (API) exposed by the software service instance;
creating, by the software service instance, a log entry including information pertaining to the invocation of the API and a call flow tag, wherein the call flow tag includes an identifier of a call flow to which the invocation of the API belongs and an ordered series of one or more sub-identifiers indicating a position of the invocation within the call flow; and
writing, by the software service instance, the log entry to a log store of the layered software system.

20. A computer readable storage medium having stored thereon program code executable by a computer system, the program code causing the computer systems to:
receive an invocation message indicating invocation of an application programming interface (API) exposed by a software service instance running on the computer system;
create a log entry including information pertaining to the invocation of the API and a call flow tag, wherein the call flow tag includes an identifier of a call flow to which the invocation of the API belongs and an ordered series of one or more sub-identifiers indicating a position of the invocation within the call flow; and
write the log entry to a log store.
